(19) United States
(12) Patent Application Publication
(10) Pub. No.: US 2010/0209897 A1
(43) Pub. Date: Aug. 19, 2010

(54) Intraoral behavior monitoring and aversion devices and methods

(76) Inventors: David Scott Utley, Redwood City, CA (US); Michael Berman, Minnetonka, MN (US); Peter T. Keith, Lanesboro, MN (US); Robert E. Atkinson, White Bear Lake, MN (US); Jack Denton Utley, JR., Fairview, PA (US)

Correspondence Address: BECK AND TYSVER P.L.L.C., 2900 THOMAS AVENUE SOUTH, SUITE 100, MINNEAPOLIS, MN, 55416, US

(21) Appl. No.: 12/590,073

(22) Filed: Nov. 2, 2009

Related U.S. Application Data
(63) Continuation-in-part of application No. 10/943,379, filed on Sep. 17, 2004, now Pat. No. 7,610,919.
(60) Provisional application No. 60/575,679, filed on May 28, 2004.

(51) Int. Cl. G09B 19/00

(52) U.S. Cl. 434/238; 434/236

(57) ABSTRACT

An intraoral behavior monitoring and aversion device to assist a user in quitting an undesirable behavior such as tobacco smoking, tobacco chewing, use of snuff, illicit drug use, excessive alcohol consumption, excessive food consumption, and/or other undesirable activity facilitated via the mouth. The aversion device may be wholly or partially configured to be disposed in the user's mouth, for example. The aversion device may include a detector and a output device, wherein the detector is configured to detect a parameter indicative of the user engaging in the habit or undesirable activity. If (and only if) the detector detects such a parameter, the output device may, optionally, deliver a negative stimulus to the user, thus providing negative feedback and creating an incentive for the user to limit if not eliminate the undesirable activity. The device may be configured to store and/or relay data representing sensed conditions in the mouth.

### CROSS REFERENCE TO RELATED APPLICATION

The present application is a continuation-in-part of U.S. Ser. No. 10/943,379, filed Sep. 17, 2004 which in turn claims the benefit of U.S. Provisional Patent Application No. 60/575,679 filed May 28, 2004, the entire disclosures of which are hereby incorporated by reference.

### FIELD OF THE INVENTION

The present invention relates to intraoral behavior monitoring and aversion devices and methods, such as smoking cessation devices and methods.

### BACKGROUND OF THE INVENTION

There exist numerous behaviors that are facilitated via the mouth which have serious health consequences. Some of these behaviors include tobacco smoking, illicit drug use, excessive alcohol consumption, and/or excessive food consumption. Unfortunately, the addictive nature of these behaviors creates a great challenge to the afflicted individual if he or she desires to limit or stop such behavior.

Smoking, for example, is a prime example of an addictive behavior with negative health implications. Smoking in all of its forms continues to be a major contributor to serious health problems worldwide. Major health problems related to smoking include various types of cancers, cardiovascular disease, stroke, hypertension, emphysema, chronic bronchitis, asthma, ulcers, and gum disease, among others. Smokers who successfully quit can dramatically reduce their risks for acquiring these health problems.

In the United States alone, approximately 50 million people smoke. It is estimated that 20 million of these individuals make a serious attempt to quit smoking each year. Techniques used to achieve smoking cessation include nicotine replacement, counseling, aversion therapies, hypnosis, pharmacological treatments, and quitting “cold turkey”, among others. However, the vast majority of these individuals resume smoking within a few months of their attempted cessation. Even the most successful cessation techniques rarely achieve greater than a ten percent success rate at one year.

Smoking is a powerfully addictive behavior. Successful quitting typically requires tremendous willpower on the part of the individual to keep from resuming the smoking behavior. Certain aversion techniques have been employed with some success. Aversion techniques seek to alter the smoker's psycho-physiological reaction to smoking, from that of a pleasant experience to an unpleasant experience. This may be done by delivery of a negative, unpleasant stimulus to the smoker when he or she smokes.

One aversion technique includes the use of silver acetate tablets taken orally by the smoker. Subsequent smoking causes a reaction between constituents in the smoke and the silver acetate, resulting in a very unpleasant taste. When successfully followed, this technique can modify the smoker's behavior, but this technique requires the individual to willfully continue to consume the tablets on a daily basis. Long-term compliance by the individual is suboptimal with this technique, and therefore this cessation technique is often unsuccessful.

Other aversion cessation techniques similarly allow too much opportunity for the individual to avoid compliance, thus diminishing their associated effectiveness. There is therefore a potential role for an aversion technique (e.g., a smoking cessation technique) that seeks to modify the user's behavior through aversion, while limiting opportunities for non-compliance.

### SUMMARY OF THE INVENTION

To address this and other needs, the present invention provides various embodiments of an intraoral monitoring and aversion device and method. The device may be used, for example, to assist a user in quitting an undesirable activity or habit such as tobacco smoking, tobacco chewing, use of snuff, illicit drug use, excessive alcohol consumption, and/or excessive food consumption, or other undesirable activity facilitated via the mouth. To this end, the aversion device may be wholly or partially configured to be disposed in the user's mouth. If the monitoring and aversion device is partially configured to be disposed in the user's mouth, then the other portions may be configured to be carried or worn by the patient or implanted in the patient. Placement in the mouth allows the device to readily detect the undesirable activity, limits the ability of the user to remove or defeat the device, and provides easy access for the health care professional.

The monitoring and aversion device may include a detector and an output device. The detector is configured to detect a parameter that is indicative of the user engaging in the habit or undesirable activity. The output device is configured to generate a signal perceivable by the user or perceivable by someone with influence over the user, such as a delivering a negative stimulus to the user, if the detector detects such a parameter. If the detector does not detect such a parameter, the output device does not generate the signal (e.g., does not deliver a negative stimulus to the user). Thus, the device may deliver a negative stimulus when the user engages in the undesirable activity and may ultimately condition against engagement in the undesirable activity.

The monitoring and aversion device may be configured to store and/or relay to an external device data representative of conditions in the oral cavity, such as CO levels. This logging may be instead of or in addition to delivering an alert or negative stimulus to the user.

Illustrative embodiments of an intraoral monitoring and aversion device are described in more detail hereinafter.

### BRIEF DESCRIPTION OF THE DRAWINGS

FIG. 1 is a schematic block diagram of a generic embodiment of an intraoral aversion device;

FIG. 2 is a schematic illustration showing various possible locations in the mouth to place the aversion device illustrated in FIG. 1;

FIGS. 3A-3D are schematic illustrations showing various possible attachment points for the aversion device illustrated in FIG. 1;

FIGS. 4A-4D are schematic illustrations showing various possible sensor orientations for the aversion device illustrated in FIG. 1;

FIGS. 5-8 are flow charts illustrating various methods of using the aversion device illustrated in FIG. 1;

FIGS. 9A-9B are posterior and inferior views, respectively, of a smoking aversion device configured to be disposed in the palatal space and attachment to a plurality of teeth; and

FIGS. 10A-10C are cross sectional views of various sensor interface arrangements for the smoking aversion device illustrated in FIGS. 9A-9B.

FIGS. 11a and 11b are schematic block diagrams of an embodiment of an intraoral monitoring and aversion device, incorporating a data relay module to relay data to a separate device. The embodiment of FIG. 11a includes on-board data storage for storing data.

FIGS. 12a-12d are schematic diagrams illustrating configurations that can be employed for relaying data from the intraoral device to external device(s).

FIG. 13 is a schematic diagram of a relay station for use in conjunction with the intraoral device(s) of FIGS. 11a and 11b.

FIG. 14 is a perspective diagram of the relay station of FIG. 13, showing various ways for the data from an intraoral device of FIGS. 11a and 11b to be transferred to a relay station of FIG. 13.

### DETAILED DESCRIPTION OF THE INVENTION

The following detailed description should be read with reference to the drawings in which similar elements in different drawings are numbered the same. The drawings, which are not necessarily to scale, depict illustrative embodiments and are not intended to limit the scope of the invention.

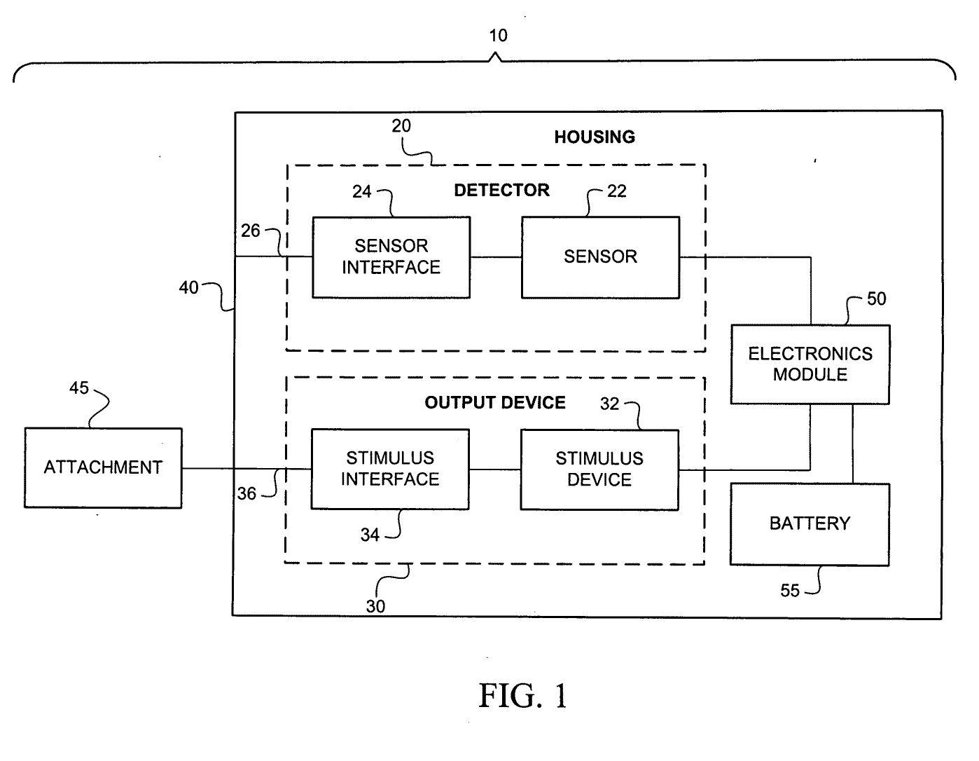

With reference to FIG. 1, an aversion device 10 is shown schematically by block diagram. The aversion device 10 may be used, for example, to assist a user in quitting a habit or undesirable activity such as tobacco smoking. The aversion device 10 may be wholly or partially configured to be disposed in the user (e.g., oral cavity) to improve patient compliance by limiting the user's ability to remove or defeat the functionality of the device 10. The aversion device 10 may include a detector 20 operably connected to an output device 30. The detector 20 may detect a parameter that is indicative of the user engaging in the habit or undesirable activity. If the detector 20 detects a parameter indicative of the user engaging in an undesirable activity, the output device 30 may generate a signal perceivable by the user or perceivable by someone with influence over the user, such as delivering a negative stimulus to the user. Thus, the intraoral aversion device 10 may deliver a negative stimulus to the user when the user engages in the undesirable activity, and may ultimately condition against engagement in the undesirable activity.

The aversion device 10 may be used, for example, to assist a user in quitting an undesirable behavior such as tobacco smoking, tobacco chewing, use of snuff, illicit drug use, excessive alcohol consumption, and/or excessive food consumption, or other undesirable activity facilitated via the mouth. To this end, the aversion device 10 may be wholly or partially configured to be disposed in the user's mouth, for example. Placement in the mouth allows the device 10 to readily detect the habit or undesirable activity facilitated therethrough, and optionally deliver an adverse stimulus therein. Placement in the mouth also limits the user's ability to remove or defeat the device 10, thus improving patient compliance. Placement in the mouth further provides the health care professional ready access to place the device 10 in the user.

To facilitate placement in the user, at least one of and preferably both of the detector 20 and the output device 30 may be disposed in a housing 40 configured to be disposed in a cavity of the user (e.g., oral cavity) or configured for implantation in the user. For example, the housing 40 may comprise a biocompatible material (e.g., stainless steel, polycarbonate, silicone) and may be sealed (water resistant, water proof, or hermetic) to protect the internal components from the harsh environment inside the mouth. If the detector 20 is disposed in the housing 40, the housing 40 may include a communication path (e.g., opening) to permit the detector 20 to detect the subject parameter in the mouth.

To further facilitate placement, the device 10 may include one or more attachments 45 to connect the housing 40 to an anatomical feature in the user's mouth, such as one or more teeth or bony structure therein. The attachment 45 may comprise one or more tooth clasps, wires, bonding agents, modified bridge or crown, or other mounting devices conventionally used to fix orthodontic appliances in the mouth. The attachment 45 may be fixedly secured to the anatomical structure using conventional dental tools and techniques such that it is easy for a dentist to place or remove the device 10, but it is difficult for the user to do so. Further attachment 45 options are described hereinafter.

The attachments 45 may be separate or integral with the remainder of the device 10. For example, if separate, the attachment may be secured in the user's oral cavity, and the remainder of the device 10 may be subsequently connected thereto. Such a connection may be made releasable such that the remainder of the device 10 may be removed and replaced, for example, while leaving the attachments in place.

The detector 20 may include a sensor 22, which may be selected to be sensitive to the parameter of interest. For example, if the undesirable activity is tobacco smoking, the sensor 22 may be responsive to the presence of one or more constituents of tobacco smoke (e.g., an electrochemical gas sensor or IR spectroscopic analyzer), the presence of smoke particulate (e.g., an ionizing radiation or photoelectric smoke detector), the presence of a vacuum in the oral cavity during inhalation of smoke (e.g., a pressure sensor or switch), or a combination thereof. If the undesirable activity is illicit drug use or excessive alcohol consumption, the sensor 22 may be responsive to the presence of one or more constituents of the illicit drug or alcohol in the oral cavity before inhalation or swallowing, or in the exhaled breath (e.g., photoelectric sensor with reagent strip color change). If the undesirable activity is excessive food consumption, the sensor 22 may be responsive to the type of food (fat or sugar products), osmolality, the amount of food, and/or the caloric value of food consumed (e.g., ultrasonic sensor with glucose meter).

The detector 20 may also include a sensor interface 24 which is configured to permit the sensor 22 to sense the parameter of interest in the target substance, but prevent the ingress of the target substance or other foreign matter into the sensor 22 or the housing 40. The sensor interface 24 may communicate through the housing 40, may comprise all or a portion of the housing 40, or may be connected thereto by interconnection 26. For example, the sensor interface 24 may be configured to communicate with the oral cavity, and/or to contact saliva or oral tissues, while preventing saliva, drinks, foods, and other forms of gases, liquids and/or solids from entering the sensor 22 or housing 40. For most sensor applications, the interface 24 may be permeable to the target substance (e.g., inhaled or exhaled breath) and/or the interrogating means (e.g., electromagnetic radiation, light, pressure) while being impermeable to other substances. For example, if the sensor 22 comprises an electrochemical gas sensor, the sensor interface 24 may comprise a membrane and/or filter that permits the ingress of certain gaseous substances from the oral cavity while preventing the ingress of liquids, solids and contaminating gaseous substances. Alternatively, if the sensor 22 comprises an IR spectrometer, the sensor interface 24 may comprise a fluid sealed IR transparent window, and/or a membrane permitting the passage of gaseous substances only. If the sensor 22 comprises a photoelectric smoke detector, the sensor interface 24 may comprise a fluid sealed light transparent window, and/or a filter permitting the passage of gaseous substances and smoke particulate only. If the sensor 22 comprises an ionizing radiation smoke detector, the sensor interface 24 may comprise a fluid sealed barrier with low electromagnetic attenuation (e.g., non-metallic, polymeric, glass, ceramic), and/or a filter permitting the passage of gaseous substances and smoke particulate only. If the sensor 22 comprises a pressure sensor or switch, the sensor interface may comprise a fluid sealed diaphragm. If the sensor 22 comprises a photoelectric sensor with reagent color change, the sensor interface 24 may comprise a fluid sealed light transparent window for the photoelectric sensor and a membrane or filter for the reagent strip.

In some instances, the sensor 22 and the sensor interface 24 may be single use or may become less effective over time. For example, reagent strips usually undergo a color change in the presence of the target parameter, but do not change back to their original color. Accordingly, the sensor 22 and the sensor interface 24 may be configured for removal and replacement. For example, the sensor 22 and the sensor interface 24 may comprise a replaceable cartridge. Other portions of the device 10 may be similarly configured for replacement, including, without limitation, the output device 30 and the battery 55.

The output device 30 may include a stimulating device 32 which may be selected to generate one or more effective signals that are perceivable by the user or perceivable by someone with influence over the user, such as negative stimuli delivered to the user. The negative stimulus may comprise an electrical, mechanical, chemical, thermal, audible, or visible stimulus, for example, or a combination thereof. The stimulating device 32 may be made adjustable and/or programmable (regressively or progressively) to suit the user and the particular application.

For electrical stimulus, the stimulating device 32 may comprise an electrical circuit that delivers an unpleasant or painful electrical pulse (e.g., shock) or series of pulses (e.g., pulse train) to the user via the housing 40 and/or attachment 45. For mechanical stimulus, the stimulating device 32 may comprise a vibrator that delivers an unpleasant or painful vibration to the user via the housing 40 and attachment 45. For chemical stimulus, the stimulating device 32 may comprise a miniature pump that secrets an agent (e.g., hydrogen sulfide, acetic acid) that is unpleasant to smell or taste, or that secretes an agent that is painful (e.g., capsaicin). For thermal stimulus, the stimulating device 32 may comprise a resistive heating element to deliver hot stimulus or a Peltier device that delivers hot or cold stimulus to thermally sensitive areas in the mouth. For audible stimulus, the stimulating device 32 may comprise an acoustic transducer (e.g., speaker) that generates an irritating or embarrassing noise. For visible stimulus, the stimulating device 32 may comprise a light source (e.g., light bulb or light emitting diode) that generates sufficient light to be noticeable to the user and people around the user such that the user is irritated or embarrassed.

The output device 30 may also include a stimulator interface 34. The stimulator interface 34 provides a path from the stimulus device 32 to the target site for the stimulus. The stimulus interface 34 may comprise a discrete component, may be connected to the housing 40 and/or attachment 45 via interconnection 36, or may comprise the housing 40 and attachment 45. For example, for electrical stimulus, the stimulator interface 34 may comprise electrodes for attachment to one or more teeth or other tissues in the mouth, and the attachment 45 may serve as such electrodes. For chemical stimulus, the stimulator interface 34 may comprise a diffusion tube or pad for attachment to the tongue, gums or other tissues in the mouth. For thermal stimulus, the stimulus interface 34 may comprise a thermal contact. For some forms of stimulus, such as audible and visible stimulus, a stimulus interface 34 may not be necessary.

The output device 30 may incorporate a single stimulating device 32 and a single stimulus interface 34, a single stimulating device 32 and multiple stimulus interfaces 34, or multiple stimulating devices 32 with multiple stimulus interfaces 34. Similarly, the detector 20 may incorporate a single sensor 22 and a single sensor interface 24, a single sensor 22 and multiple sensor interfaces 24, or multiple sensors 22 with multiple sensor interfaces 24. The use of multiple interfaces 24, 34 reduces the likelihood of the user successfully defeating functionality of the device 10.

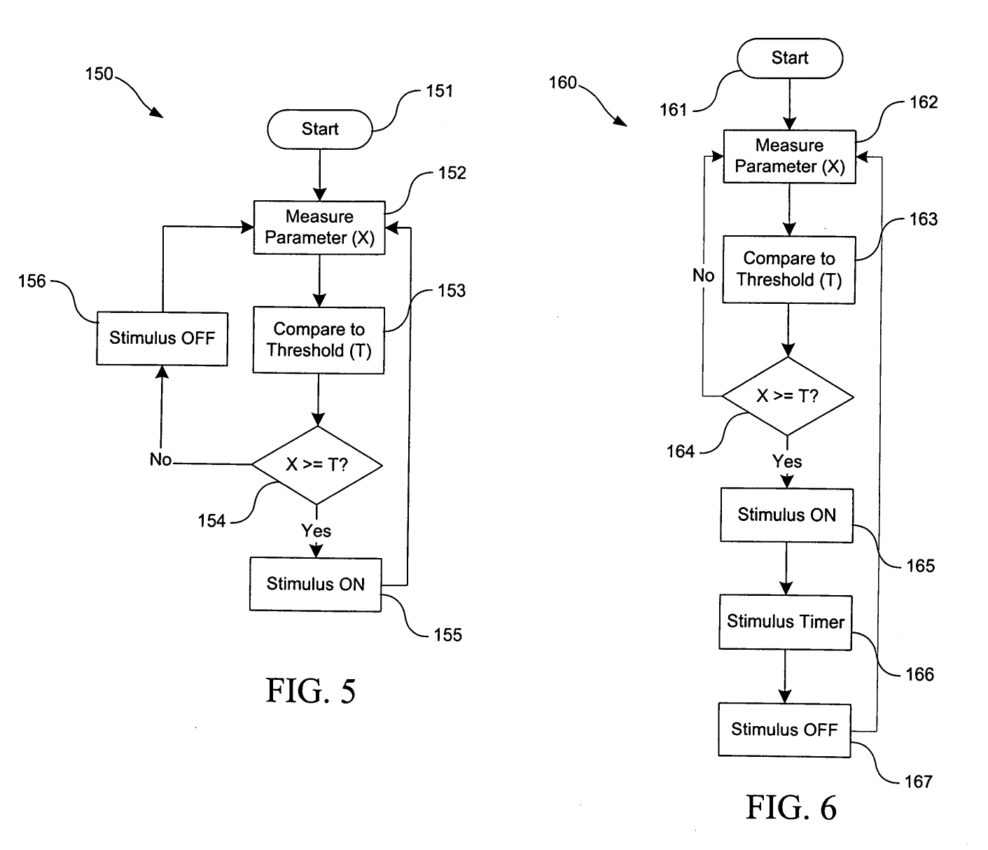

The aversion device 10 may further include an electronics module 50 disposed in the housing 40 to control the sensor 22 and stimulation device 32. Electrical power may be provided to the electronics module 50, and to the sensor 22 and stimulation device 32 via electronics module 50, by battery 55. As those skilled in the art will recognize, the electronics module 50 will vary depending on the particular detector 20 and output device 30 utilized. Generally, the electronics module 50 samples for the target parameter using the detector 20 and triggers a negative stimulus using the output device 30. For example, the electronics module 50 may operate to perform the processes described with reference to FIGS. 5-8. These processes may be embedded in hardware, software or firmware, and the electronics module 50 may be configured accordingly. For software and firmware modes, a program may be used to define the processes, and the electronics module 50 may include a processor for executing the program connected to a memory device for storing the program.

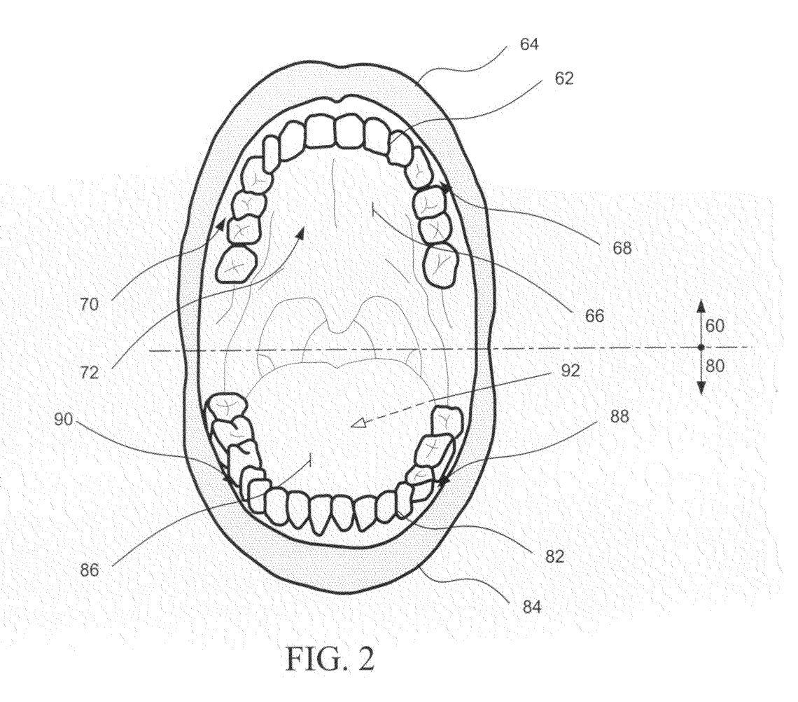

With reference to FIG. 2, various possible placement locations for the aversion device 10 are shown and described. To facilitate a description of suitable placement locations for device 10, an anatomical description of the mouth follows.

FIG. 2 illustrates an open mouth or oral cavity, including an upper portion 60 and a lower portion 80. The upper portion 60 includes upper teeth 62, an upper lip 64, and a palate 66. The spaces between the upper lip 64 and the upper teeth 62 are the upper left and the upper right gingival-buccal and dental-buccal spaces (collectively referred to herein as upper buccal spaces 68, 70). The space adjacent the palate 66 is the palatal space 72. The lower portion 80 includes lower teeth 82, a lower lip 84, and a tongue 86. The spaces between the lower lip 84 and the lower teeth 82 are the lower left and the lower right gingival-buccal and dental-buccal spaces (collectively referred to herein as lower buccal spaces 88, 90). The space beneath the tongue 86 is the sublingual space 92.

The device 10 may be disposed in a portion of the oral cavity that provides access to the target substance containing the target parameter, that does not significantly compromise oral function (e.g., breathing, eating, drinking, speaking, etc.), and that does not cause trauma to or otherwise modify oral anatomy. Examples of suitable placement locations for all or portions of device 10 include the upper left or upper right buccal spaces 68, 70, the palatal space 72, the lower left or lower right buccal spaces 88, 90, and the sublingual space 92.

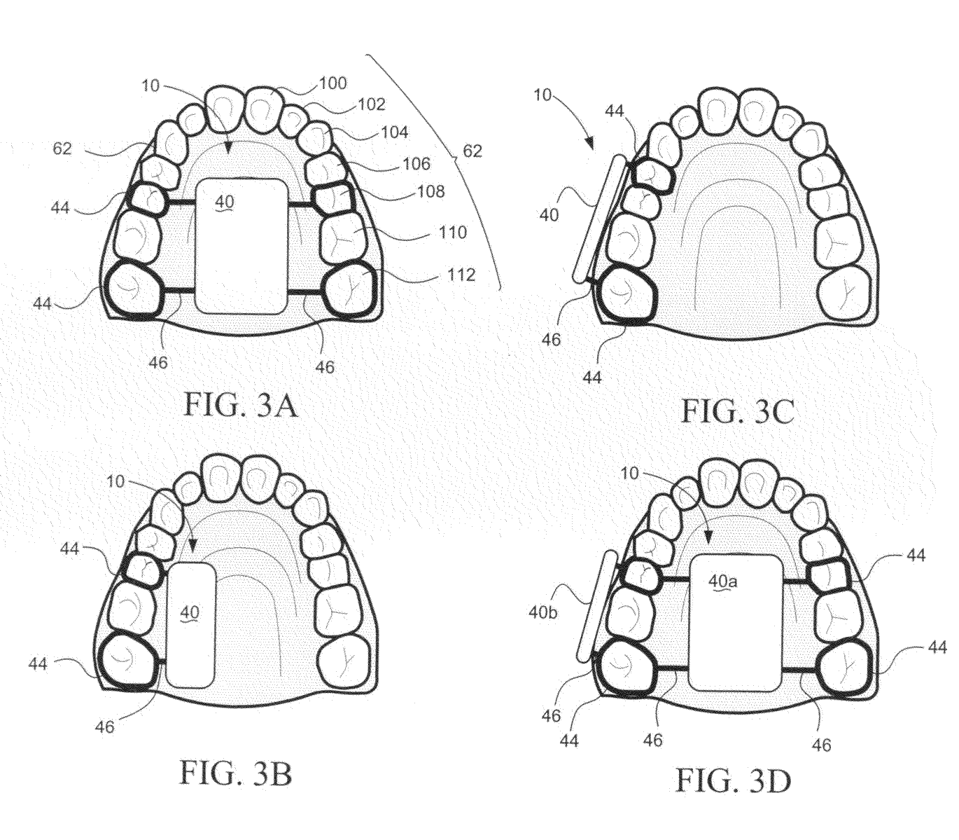

With reference to FIGS. 3A-3D, various possible attachment locations for the aversion device 10 are shown and described. FIGS. 3A-3D are intended to generically refer to either the upper teeth 62 or the lower teeth 82. By way of example, not limitation, the attachment locations are described with respect to upper teeth 62, but may also be applied to the lower teeth 82. The upper teeth 62 include the central incisor 100, lateral incisor 102, canine 104, first bicuspid 106, second bicuspid 108, first molar 110, and second molar 112. Some people also possess third molars (wisdom teeth), which are not shown. As the upper teeth 62 are generally symmetric, the left and right sides each include the above mentioned types of teeth.

Generally, the device 10 may be attached to the user's teeth or bony structure in the oral cavity using an attachment device 45 as shown and described with reference to FIG. 1. For tooth-based fixation, the attachment point or points may be lingual or buccal for tooth-based fixation, depending on the desired location of the device. The device 10 may have 1-2 mm of clearance from all mucosal structures (like the palate) for better sensing and hygiene. By way of example not limitation, the attachment 45 may comprise an orthodontic molar and/or bicuspid band; a direct bonded bracket, pad, or other device; a clasp (as used in an orthodontic retainer) that traverses the embrasure (area between teeth) affixed with an adhesive product or not fixated; interdental wire or bar; and/or labial bow wire (with anterior fixation) affixed to the enamel with an adhesive product or not fixated. For bony structure fixation, bone screw(s) may be placed in hard palate, maxilla, mandible or other bony structure.

In the examples illustrated in FIGS. 3A-3D, the attachment 45 is shown to comprise a clasp 44 connected to the housing 40 by a connector 46, but may comprise other attachment means such as wire, bonding agent, modified bridge or crown, etc. The device 10 may be attached bilaterally as shown in FIGS. 3A and 3D, or unilaterally as shown in FIGS. 3B and 3C. The device 10 may be disposed on the palatal side of the teeth 62 as shown in FIGS. 3A and 3B, on the buccal side of the teeth 62 as shown in FIG. 3C, or on both sides of the teeth 62 as shown in FIG. 3D.

FIG. 3A shows an arrangement in which the device 10 is positioned in the palatal space 72 (or the sublingual space 92), and is attached bilaterally to one or more of the teeth 62 on each side of the mouth. As shown, the device 10 is connected to four teeth, left and right second bicuspids 108, and left and right second molars 112. It is contemplated that the device 10 could be attached to any combination of the teeth 62. The attachment illustrated comprises clasp 44 and connector 46 between clasp 44 and housing 40. Clasp 44 may comprise a circumferential band, such as that used commonly in orthodontic appliances. Connector 46 can be a metallic structure such as a wire. Depending on the size and shape of the housing 40, a connector 46 may not be necessary, in which case the clasp 44 may be directly connected to the housing 42. Alternatively the housing 40 (and connector 46) may be attached to one or more of the teeth 62 by means of an adhesive bond such as is commonly used to affix orthodontic braces to the teeth.

FIGS. 3B and 3C show arrangements wherein the device 10 is connected unilaterally on one side (left or right) of the teeth 62. The device 10 may be disposed in the palatal space 72 (or sublingual space 92) as illustrated in FIG. 3B, or in any of the upper buccal spaces 68, 72 (or lower buccal spaces 88, 90) as shown in FIG. 3C.

Alternatively, the device 10 may be disposed in both the palatal space 72 (or sublingual space 92) and one of the upper buccal spaces 68, 70 (or lower buccal spaces 88, 90), as shown in FIG. 3D. To this end, the device 10 may be partitioned into two (or more) discrete portions having multiple housings 40a, 40b as shown in FIG. 3D, rather than utilizing a unitary housing 40 as shown in FIGS. 3A-3C. For example, the detector 30, electronic module 50 and battery 55 may be disposed in housing 40a, and the output device 30 may be disposed in housing 40b, with electrical interconnections therebetween being provided via connectors 46. Any number of attachments 45 (and housings 40) are contemplated for device 10 to make use of any number and combination of the placement locations previously described.

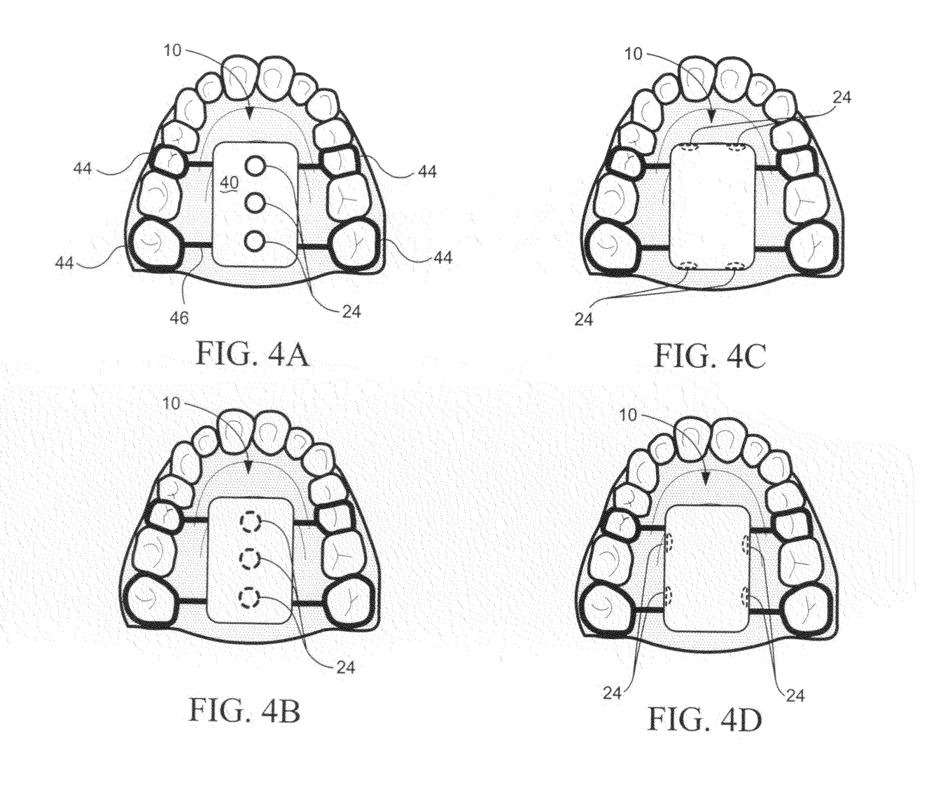

With reference to FIGS. 4A-4D, various possible sensor orientations for the aversion device 10 are shown and described. FIGS. 4A-4D are intended to generically refer to either the upper portion 60 or the lower portion 80 of the mouth. By way of example, not limitation, the sensor orientations are described with respect to the upper portion 60, but may also be applied to the lower portion 80.

Generally, the detector 20 may incorporate a single sensor 22 and a single sensor interface 24, a single sensor 22 and multiple sensor interfaces 24, or multiple sensors 22 with multiple sensor interfaces 24. FIGS. 4A-4D show devices 10 utilizing multiple sensor interfaces 24 to provide multiple sampling sites which increases the likelihood of successful detection and reduces the likelihood of the user successfully defeating functionality of the device 10. The orientations illustrated in FIGS. 4A-4D may be applied to single or multiple sensor interfaces 24, and may be taken alone or in combination.

In FIG. 4A, the device 10 is disposed in the palatal space 72 adjacent the palate 66 with the sensor interfaces 24 facing inferiorly (towards tongue). In FIG. 4B, the device 10 is disposed in the palatal space 72 spaced from the palate 66 with the sensor interfaces 24 facing superiorly (towards the palate 66). In FIG. 4C, the sensor interfaces 24 face anteriorly and/or posteriorly (front/back), and in FIG. 4D, the sensor interfaces 24 face laterally (right/left).

These orientations may be taken alone or in any combination, may be applied to a device 10 in any placement position (palatal, lingual, buccal), and may be applied to a device 10 with any attachment location. Generally, sensor interface 24 orientations that are less accessible to the user (and thus better protected from user defeat) may also have less access to the target substance and the target parameter. Thus, the number and orientation of the sensor interfaces 24 may be selected to balance the likelihood of successful detection with the likelihood of user defeat.

With reference to FIGS. 5-8, various methods of using the aversion device 10 are shown by flow chart. These processes may be embedded in hardware, software or firmware, and may be executed by the electronics module 50 as described previously. In general, the detector 20 samples the target parameter (X) in the target substance in the oral cavity and measures the parameter for comparison to a certain threshold (T). If the measured parameter exceeds the threshold, the output device 30 delivers the negative stimulus to the user. Preferably, the detector 20 measures the parameter with sufficient selectivity, sensitivity and accuracy to minimize false positives and false negatives. To this end, the parameter or parameters selected for measurement are preferably indicative of and unique to the habit or undesirable activity, relative to other activities facilitated via the oral cavity (e.g., eating, drinking, breathing, etc.).

If the stimulus is triggered on, the stimulus may be triggered off when the measured parameter ceases to exceed the threshold (i.e., stimulus continuously delivered until the measured parameter does not exceed the threshold) as shown and described with reference to FIG. 5. Alternatively, if the stimulus is triggered on, the stimulus may be triggered off after a preset period of time as shown and described with reference to FIG. 6. For purposes of determining the stimulus trigger (on and off), the measured parameter (X) may be compared to the threshold (T), or a time derivative (dX/dt) of the measured parameter may be compared to the threshold (T) as shown and described with reference to FIG. 7. Also for purposes of determining the stimulus trigger (on and off), the threshold (T) may be a constant value (k), or may be a function of the measured parameter (X), the number of times (n) the detector 20 has detected the parameter (X), the amount of time (t) the detector 20 has detected the parameter (X), and/or the amount of time the device has been disposed in the oral cavity, as shown and described with reference to FIG. 8. Each of the variants described with reference to FIGS. 5-8 may be taken alone or in any combination.

With specific reference to FIG. 5, a method 150 of using the aversion device 10 is shown by flow chart. This method 150 generally calls for the stimulus to be continuously delivered as long as the detected parameter (X) exceeds the threshold (T). The method 150 starts 151 by the detector 20 sampling and measuring 152 the target substance containing the target parameter (X). The measured parameter (X) is compared 153 to the threshold (T) to determine 154 if the measured parameter (X) is equal to or exceeds the threshold (T). If the measured parameter (X) is greater than or equal to the threshold (T), the output device 30 is triggered ON 155 to deliver the negative stimulus to the user. If the measured parameter (X) is not greater than or equal to the threshold (T), the output device 30 is triggered OFF 156 (if it is not already off). In either case, the detector 20 continues to sample and measure 152 the parameter (X) and make comparisons 153 to the threshold (T) to determine 154 if the measured parameter (X) is greater than or equal to the threshold (T). Thus, if the stimulus is triggered ON 155, the stimulus is subsequently triggered OFF 156 when the measured parameter (X) ceases to exceed the threshold (T).

With specific reference to FIG. 6, another method 160 of using the aversion device 10 is shown by flow chart. This method 160 generally calls for the stimulus to be delivered for a set period of time after the detected parameter (X) exceeds the threshold (T). The method 160 starts 161 by the detector 20 sampling and measuring 162 the target substance containing the target parameter (X). The measured parameter (X) is compared 163 to the threshold (T) to determine 164 if the measured parameter (X) is equal to or exceeds the threshold (T). If the measured parameter (X) is greater than or equal to the threshold (T), the output device 30 is triggered ON 165 to deliver the negative stimulus to the user. Once the output device 30 is triggered ON 165, a time delay is initiated 166. The timer is preset to the desired amount of time the stimulus is to be delivered, which may be fixed or variable. Once the time delay is complete, the output device 30 is triggered OFF 167 and the sequence begins again at 162. Thus, the stimulus is delivered for a set period of time once the detected parameter (X) exceeds the threshold (T).

With specific reference to FIG. 7, yet another method 170 of using the aversion device 10 is shown by flow chart. This method 170 generally calls for a time derivative (dX/dt) of the measured parameter (X) to be compared to the threshold (T), rather than simply comparing the measured parameter (X) to the threshold (T). The method 170 starts 171 by the detector 20 sampling and measuring 172 the target substance containing the target parameter (X). The time derivative (dX/dt) of the measured parameter (X) is calculated 173, wherein dX may correspond to the change in the measured parameter from the immediately prior measurement, and dt may correspond to the elapsed time from the immediately prior measurement or any other suitable time increment. The time derivative calculation 173 may require the use of a timer routine and an initial measurement which are not illustrated in FIG. 7. The measured parameter time derivative (dX/dt) of the measured parameter (X) is then compared 174 to the threshold (T) to determine 175 if the time derivative (dX/dt) of the measured parameter (X) is equal to or exceeds the threshold (T). The remainder of the method 170 (trigger ON step 176 and trigger OFF step 177) may be the same as those described with reference to method 150 or method 160 described previously.

With specific reference to FIG. 8, yet another method 180 of using the aversion device 10 is shown by flow chart. This method 180 generally illustrates that the threshold (T) may be fixed or variable. For example, the threshold (T) may be a constant value (k) preset by the manufacturer, that may be optionally modified by a physician. Alternatively, the threshold (T) may be a function of the measured parameter (X), the number of times (n) the stimulus has been triggered, and/or the amount of time (t) the measured parameter (X) is equal to or exceeds the threshold (T). For example, if the stimulus has been triggered several times (e.g., n>2), then the threshold (T) may be reduced to mitigate against continued engagement in the undesirable activity. Alternatively, if the measured parameter (X) is equal to or exceeds the threshold (T) for an extended period of time (e.g., t>60 seconds), then the threshold (T) may be reduced to mitigate against continued engagement in the undesirable activity.

With continued reference to FIG. 8, the method 180 may be similar to method 170 with the exception of step 182 wherein the threshold (T) is set. Specifically, the method 180 starts 181 with the setting 182 the threshold (T) to be equal to a constant value (k), or to some function of X, n, or t. If the threshold (T) is a function of X, n or t, then the threshold may be initially set to a temporary value since the variables (X, n, and t) will initially be zero or undetermined. The detector 20 then samples and measures 183 the target substance containing the target parameter (X). The time derivative (dX/dt) of the measured parameter (X) is calculated 184 and compared 185 to the threshold (T) to determine 186 if the time derivative (dX/dt) of the measured parameter (X) is equal to or exceeds the threshold (T). The remainder of the method 180 (trigger ON step 187 and trigger OFF step 188) may be the same as those described with reference to method 170 described previously.

In a similar manner, the stimulus (S) may be a constant value (e.g., mild, medium or strong) or variable. The stimulus (S) may vary as a function of the measured parameter (X), the number of times (n) the detector 20 has detected the parameter (X), the amount of time (t₁) the detector 20 has detected the parameter (X), and the amount of time (t₂) the device has been disposed in the oral cavity. If the stimulus (S) is a function of X, n or t, then the stimulus (S) may be initially set to a temporary value (e.g., mild, medium or strong) since the variables (X, n, and t) will initially be zero or undetermined. In the variable mode, the stimulus (S) may be a progressive function of X, n, t₁, or 1/t₂, or a regressive function of t₂, 1/X, 1/n, or 1/t₁.

The preceding description is generically directed to aversion devices and methods that assist a user in quitting an undesirable activity facilitated via the mouth, such as tobacco smoking, illicit drug use, excessive alcohol consumption, and excessive food consumption. To facilitate further discussion, the intraoral aversion device 10 is described with specific reference to a tobacco smoke aversion device 10, but the same or similar principles may be applied to other undesirable activities facilitated via the mouth.

For a tobacco smoke aversion device 10, the sensor 22 may be responsive to the presence of one or more gas or particulate constituents of tobacco smoke (e.g., an electrochemical gas sensor or IR spectroscopic analyzer), the presence of smoke particulate (e.g., an ionizing radiation or photoelectric smoke detector), the presence of a vacuum in the oral cavity during inhalation of smoke (e.g., a pressure sensor or switch), or a combination thereof. For a sensor 22 that detects a constituent of tobacco smoke, suitable constituents (i.e., the target parameter (X)) include high levels (levels higher than ambient conditions) of carbon dioxide, carbon monoxide, nitrogen oxides, ammonia, nicotine, acetone, acetaldehyde, formaldehyde, hydrogen cyanide, isoprene, methyl ethyl ketone, benzene, toluene, phenol, acrylonitrile, and other chemicals found in tobacco smoke.

The following embodiments focus on an electrochemical sensor 22 that is sensitive to the presence of carbon monoxide, but the same or similar principles may be applied to other sensors for detecting other constituents of tobacco smoke as listed above. Thus, in the following embodiments, the sensor 22 comprises an electrochemical carbon monoxide gas sensor, the target parameter (X) comprises carbon monoxide and the threshold (T) may comprise 30 ppm, for example.

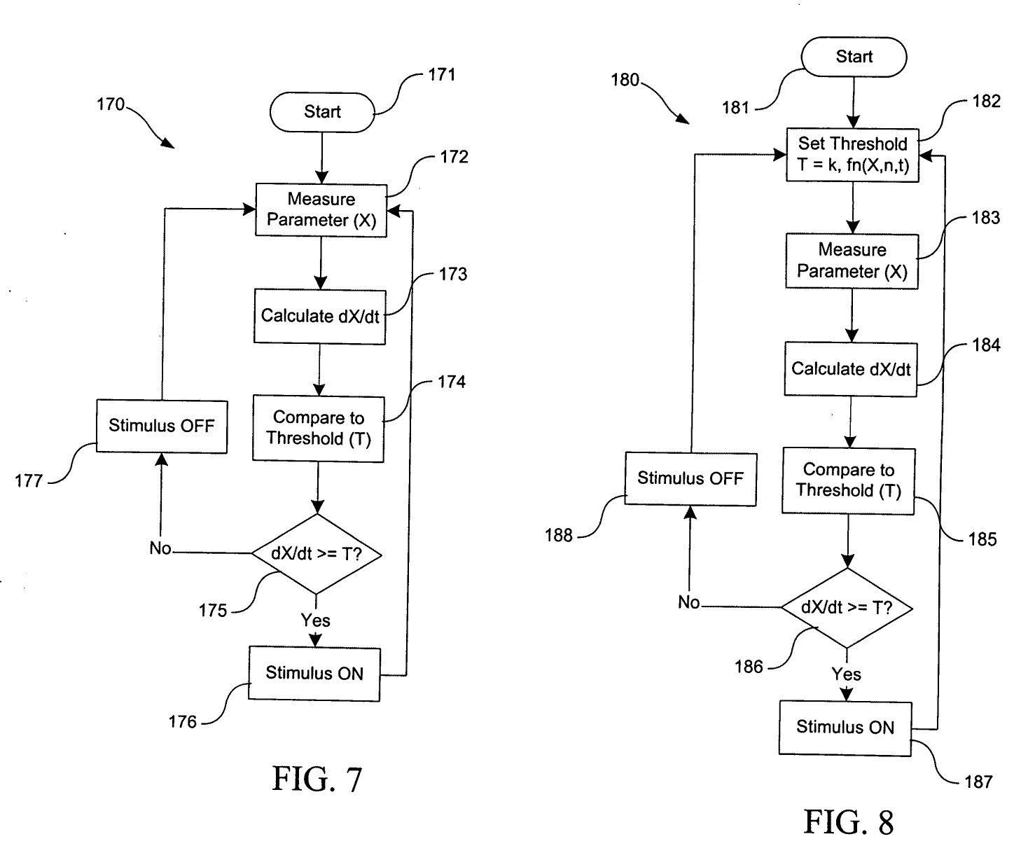

With reference to FIGS. 9A-9B, a smoking aversion device 10 configured to be disposed in the palatal space 72 and attachment to a plurality of teeth 62 is shown schematically. Specifically, FIG. 9A is a rear view of the device 10, and FIG. 9B is a bottom view of the device 10. Smoking aversion device 10 includes a detector 20 (including sensor 22 and sensor interface 24), output device 30, housing 40, attachment 45 (comprising clasps 44 and wires 46), electronics module 50 and battery 55.

To facilitate placement in the oral cavity, the housing 40 of the device 10 may be shaped to fit comfortably within the oral cavity and conform to anatomical structures therein. In the illustrated embodiment, for example, the housing 40 may be shaped to fit adjacent to the palate 66 in the palatal space 72, while having a low profile (height) to avoid interference with oral function. The housing 40 may be attached to the teeth 62 via connectors 46 and clasps 44 that engage four of the upper teeth 62.

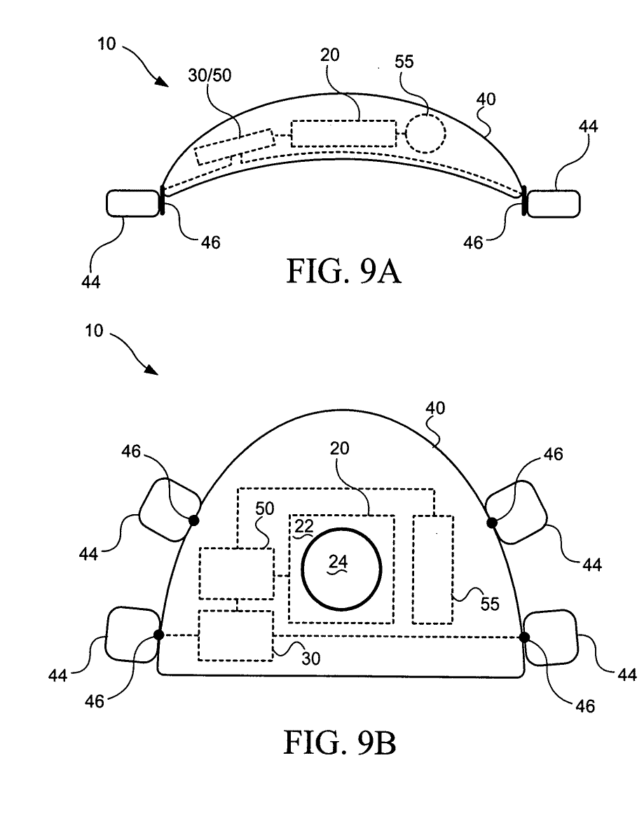

The internal components, including detector 20, output device 30, electronics module 50 and battery 55, may be arranged side-by-side as shown to minimize profile. The sensor 22 is arranged to interact with inhaled or exhaled smoke within the oral cavity via the sensor interface 24 disposed in an opening in the housing 40, examples of which are described in more detail with reference to FIGS. 10A-10C. The output device 30 delivers an electrical stimulus to the teeth 62 via electrical connection 36, connectors 46 and clasps 44.

With reference to FIGS. 10A-10C, various sensor 22 and sensor interface 24 arrangements are shown in cross sectional view. The sensor interface 24 arrangement influences the way that carbon monoxide is detected by the sensor 22. As mentioned before, the sensor 22 may comprise a miniature electrochemical gas sensor, examples of which are commercially available from Alphasense of Essex, UK and City Technology of Hampshire, UK. Such electrochemical gas sensors are quite accurate, and can measure the presence of gases to low levels such as a few parts per million (ppm).

Electrochemical gas sensors typically include a gas permeable sensor membrane 21 which contains an electrolytic chemical agent (not shown) within the sensor 22. In the case of a carbon monoxide sensor, this electrolyte is typically an acid such as sulfuric acid. A working electrode (not shown) made of a catalyst such as platinum is in contact with the electrolyte, as well as a counter electrode (also not shown). Molecules of the constituent gas (carbon monoxide) diffuse through the gas permeable sensor membrane 21, and react with the electrolyte and the working electrode, generating an electromotive force between the working electrode and the counter electrode.

With specific reference to FIG. 10A, a sensor interface 24 is shown wherein the sensor membrane 21 is directly exposed to the oral cavity, by means of an opening 25 in the housing 40. A seal 23 between the sensor 22 and housing 40 keeps saliva and other liquid or solid contents in the oral cavity from entering the interior of the detector 20. The arrangement of FIG. 10A may be highly sensitive and responsive to exposure of the constituent gas within the oral cavity. However, if food or saliva completely covers the sensor membrane 21, gas diffusion into the sensor 22 may be compromised. Also, certain types of electrochemical sensors may be sensitive to being covered in liquid water.

To address these issues, the sensor interface 24 may comprise all or a portion of the housing 40 as shown in FIG. 10B. In this embodiment, the housing may be fabricated from a gas permeable material, such as silicone rubber or permeable poly tetra-fluoroethylene (PTFE). The housing 40 may further incorporate a stiffening structure such as a wire mesh. The sensor 22 is disposed within the housing 40, and may be secured to the housing 40 by means of a bracket 27. In this arrangement, the constituent gas (carbon monoxide) can permeate at any permeable portion of the housing 40, and the sensor 22 can then detect the constituent gas within the housing 40. This arrangement essentially creates a large sensor interface 24. While this arrangement is more resistant to complete blocking of gas to the sensor 22, it may not respond as quickly to the presence of the constituent gas in the oral cavity. However, certain gas constituents such as carbon monoxide may require the detection of only trace quantities to indicate that the user is smoking.

FIG. 10C shows an alternative sensor interface 24. This arrangement is essentially identical to that shown in FIG. 10A, with the addition of a housing membrane 29 across the opening 25 in the housing 40. For sensors that are sensitive to being covered or directly exposed to liquid water, housing membrane 29 prevents such exposure. Housing membrane 29 may be fabricated from any gas permeable material, such as silicone rubber or permeable PTFE. As with the configuration of FIG. 10B, this arrangement may be slower to respond to the presence of the constituent gas in the oral cavity, but depending on the constituent gas, this may still be sensitive enough to detect the smoking behavior.

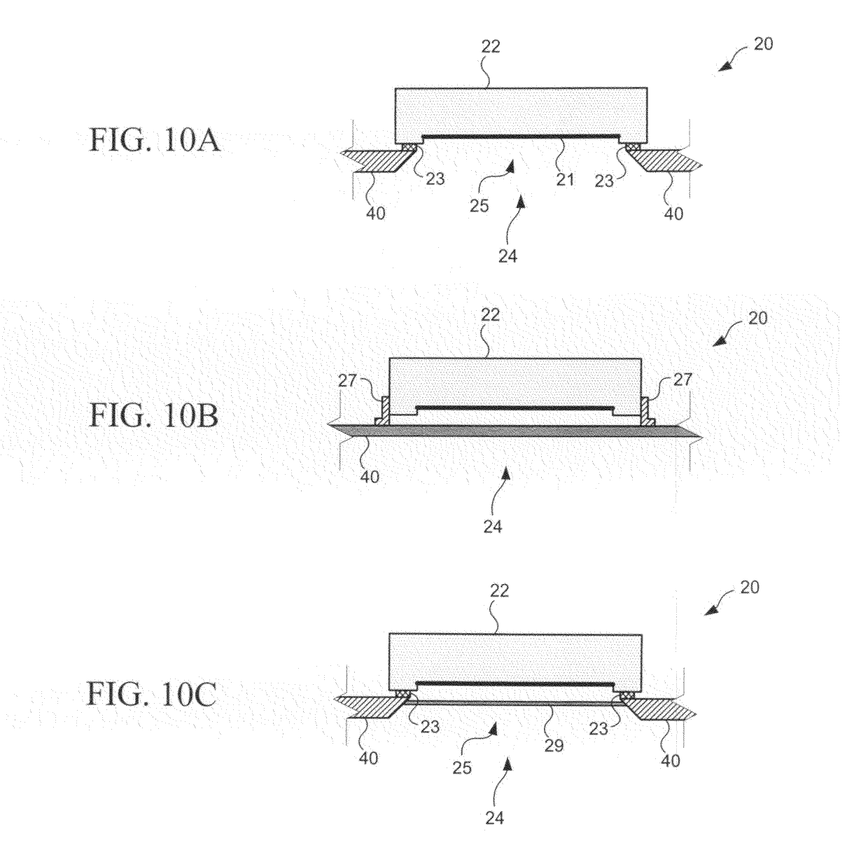

FIGS. 11-14 illustrate embodiments of an aversion device that incorporate features and functions relating to the collection of data reflecting an undesirable behavior or activity; some embodiments incorporate features and functions relating to the use of the collected data. These features make it possible for the patient, patient's family, patient's friends, or patient's healthcare providers to be informed about the patient's undesirable behavior. An objective measure of behavioral activity allows the patient and healthcare provider to more accurately adjust therapy. For the patient to be fully aware that others will review their behavioral activity, a significant degree of accountability is added which may be effective, in and of itself, in compelling a patient to avoid the undesirable behavior. Further, the data may be used to suggest or alter therapy to aid the patient in reducing or ceasing the undesired behavior. For example, if the collected data reveals that the patient has a pattern of engaging in the behavior at particular times, then the patient, armed with this knowledge, may be better able to seek support or distractions during these periods of increased risk. Further, the collected data will indicate whether adjunctive therapies are having a positive or negative effect, or no effect, on the behavior and may be titrated or changed accordingly.

More specifically, the intraoral device may be configured to store data; or data may be transmitted by the device to another component providing data storage outside of the patient's oral cavity. Such a component may be a reporting station on or near the patient's body; alternatively, “elsewhere” may be remote from the patient, such as in the offices of a health care provider.

FIG. 11a is a block diagram of a device 210, analogous to device 10 of FIG. 1, that incorporates data storage 280 coupled to the device's electronics module 250. In use, data indicative of an undesirable activity sensed by the detector 220 is converted from an analog to digital in the electronics module 250, then stored in storage 280. A data relay module 290, coupled to the data storage, relays data from the device 210 to another component outside of the patient's oral cavity.

FIG. 11b is a block diagram of another embodiment of a device 310, analogous to device 10 of FIG. 1. This embodiment differs from that of FIG. 11a in that no data storage module is included; rather, the data relay module 390 is coupled to the electronics module 350 and transmits data indicative of an undesirable activity sensed by the detector 320 to another component outside of the patient's oral cavity.

The device 210, 310 can be configured via hardware, software, or firmware to sample its environment (inside the oral cavity). This sampling can be done at a predetermined or preselected rate or frequency. This frequency can be selected with regard to the behavior being monitored, according to time of day, according to prior behavior, and/or with regard to optimizing battery life. Typically, to monitor for smoking, the device would be configured to sample at a rate of between one time per minute up to one time per second (1 Hz), although more frequent or less frequent sampling rates may be utilized. The device detects a level of a substance, such as CO, at each sampling event and stores or relays this data. When the device includes an output device and is operated in a mode to deliver a negative stimulus or alert upon detecting a behavior, the device, through hardware, software and firmware, compares the detected substance level with a predetermined threshold and, if the threshold is exceeded, the output is triggered. Alternatively, if the device is not configured with an output device or if it is operated in a mode that does not deliver a negative stimulus or alert upon detecting a behavior, then the sampled CO levels need not be compared with a threshold, but are simply stored or relayed for storage.

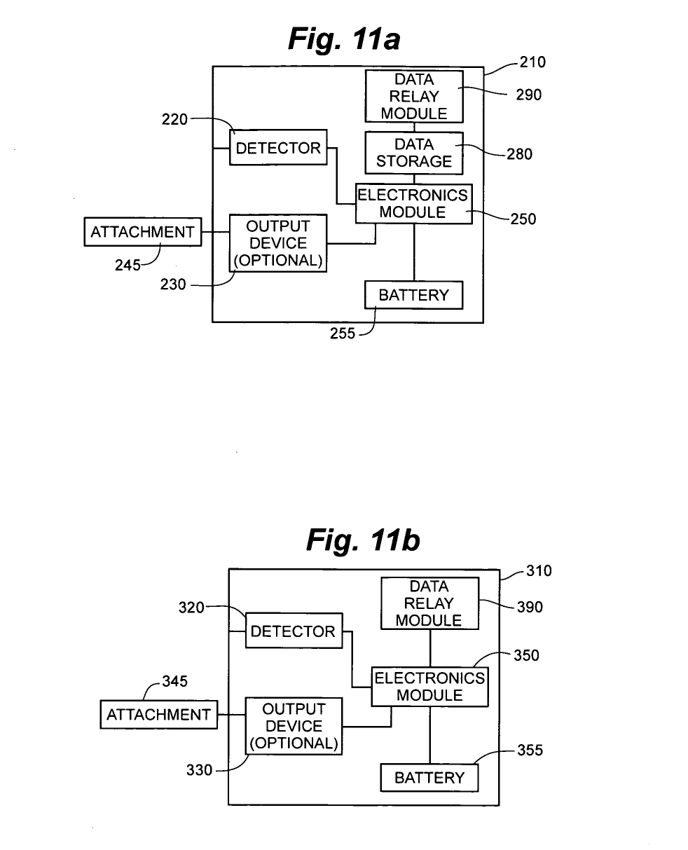

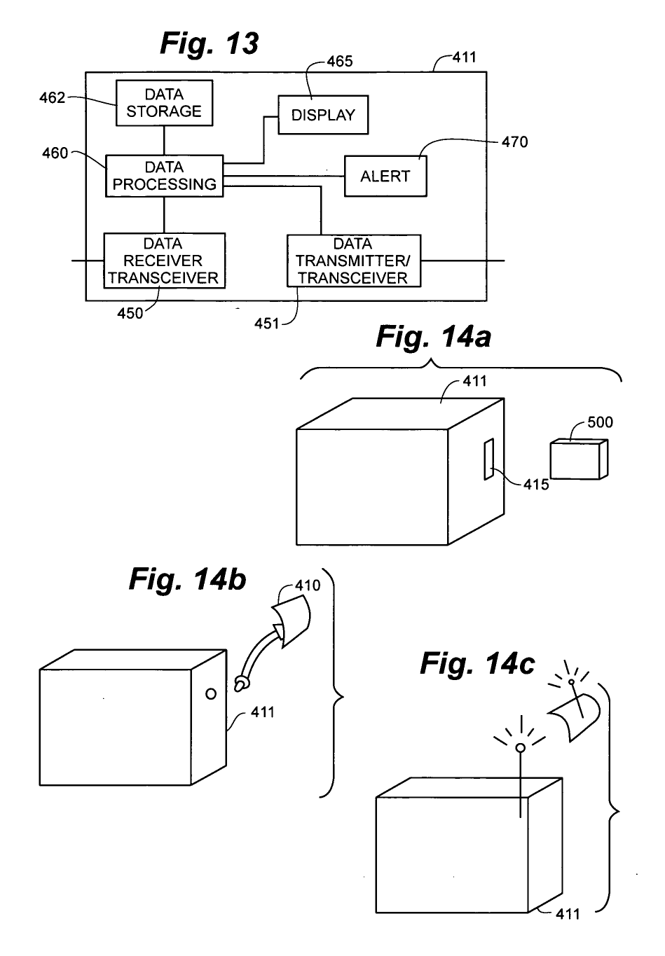

FIGS. 12a-12d illustrate several permutations of components that can be employed to store, transfer and process data sensed by the detector 20. FIG. 12a illustrates a configuration employing an intraoral device 410 and a reporting station 411. In this arrangement, the intraoral device 410 includes a data relay module that is configured for data communication with the reporting station 411. The reporting station may be held or worn by the patient or may be a bedside or tabletop unit. The configuration of FIG. 12a, wherein an intraoral device 410 communicates with reporting station 411, may be accomplished through any of the embodiments of FIG. 14a, i.e. plug-in, wired or wireless and these will be discussed below with respect to FIGS. 14a-c.

In the configuration of FIG. 12b, the intraoral device 410 transmits data to a central processing unit 550 that includes data storage and data processing components.

In the configuration of FIG. 12c, the intraoral device 410 transmits data to a reporting station 411 which in turn transmits data to a remote central processing unit 550.

In the configuration of FIG. 12d, the intraoral device 410 transmits data to a reporting station 411 via a first communication path that in turn transmits data to two or more remote central processing units 550, 551 via second communication paths.

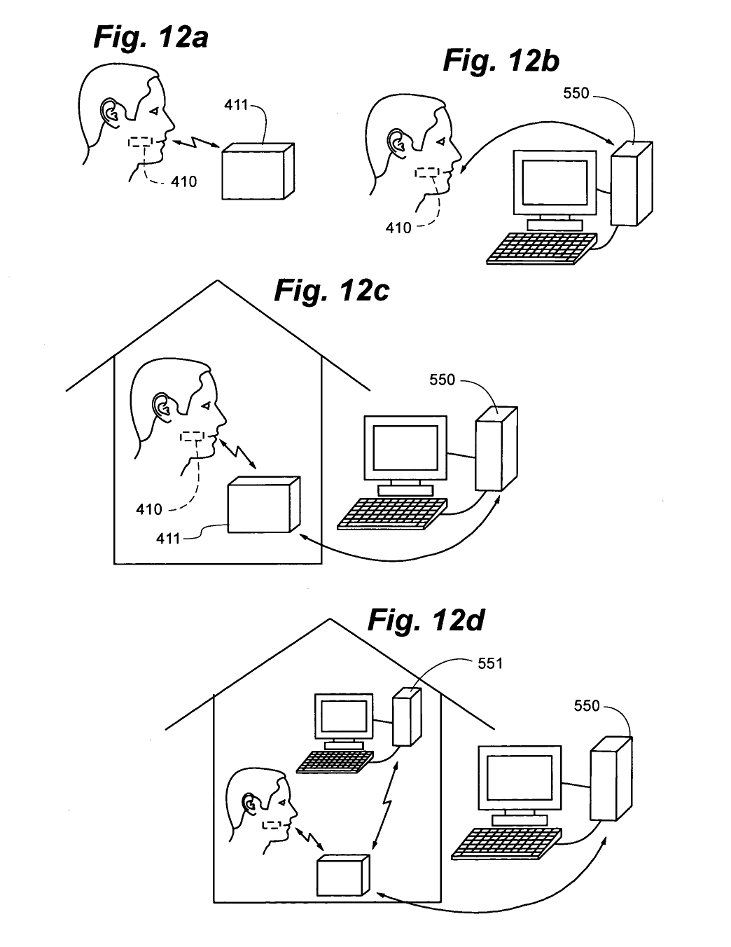

FIG. 13 shows a block diagram of a reporting station 411. The station includes a data receiver 450 for receiving data from the intraoral unit. In one embodiment, the station also includes a transmitter 451 for transmitting data to a CPU. The receiver and transmitter may be transceivers to facilitate two-way communication between the intraoral device and the reporting station and between the reporting station and a CPU. Further, the transceivers 450, 451 may be combined in a single transceiver.

The reporting station 411 further includes a data processing component 460. The reporting station 411 may include data storage 462. Optionally, the reporting station may include a display 465 and/or an alert 470, such as a light, to remind a patient to upload data or to alert when data indicates that a predetermined condition has been met.

There are a variety of ways for the intraoral device 410 of FIG. 12a to be coupled to the reporting station 411 for data transmission therebetween. For example, the intraoral device may accommodate a memory card or component 500 that is removable from the device; the reporting station 411 may include a mating reception slot 415 to receive the card 500 therein. In such a configuration, the card 500 and the slot 415 have mating electrical components, such as USB connectors, that couple when the card 500 is inserted into the slot 415, such that data can be transmitted from the chip 500 to the reporting station 411.

Alternatively, as illustrated in FIG. 14b, the device 410 (or the chip 500) and the reporting station 411 may include ports 420, 421, respectively, each for receiving a jack from a coupling cable that facilitates the transfer of data from the device 410 to the station 411.

In yet another embodiment, depicted in FIG. 14c, the device 410 has a transmitter for wireless transmission of data and the reporting station 411 is equipped with a receiver to receive the wireless transmission from the device 410.

Data may be transmitted from the intraoral device to a reporting station 411 or CPU according to a predetermined protocol. This protocol may provide for data to be relayed on command. Alternatively, this protocol may provide for data to be relayed periodically. Yet another alternative for the data transfer protocol is to transfer data upon occurrence of a predetermined condition, such as proximity of the user to a reporting station.

The electronics module of the intraoral device may include several particular circuits to aid in measuring or sensing data that is useful in analyzing a patient's behavior, such as an electrical circuit for tracking time and time stamping data collected, an electrical circuit for counting the number of occurrences of a predetermined event (such as number of times a threshold parameter is reached or the number of times a stimulus is delivered), and an electrical circuit for counting the number of stimuli delivered (if stimuli are delivered). These specialized circuits may alternatively or additionally reside in the reporting station.

The data transfer protocol may call for the deletion of stored memory in one component upon the relay of the data to another component. For example, upon transferring data from the intraoral device to a reporting station, the data could be deleted or cleared from the memory of the intraoral device. Data transfer protocols can be implemented through hardware, software and firmware running on or directing the electronics module in the intraoral device, and in the reporting station and/or remote CPU(s).

Examples of data that may be generated through sensing/measurement or through analysis/calculation of sensed/measured parameters include the following:

total time worn and monitored;

real time data of CO ppm depending on frequency of sampling;

number of output stimuli delivered (if output stimuli activated);

threshold for stimuli according to time and day

Additional data collected via other instruments or sensors or the patient's or health care professional's observations, such as blood pressure and heart rate, may be recorded in a diary and subsequently entered in the computer running the data analysis software. At that time, those secondary data can be entered along with the CO data, in a time linked manner, to reveal any associations with the data collected via the intraoral device as added measures of healthcare counseling tools. Such data may, for example, be entered via a CPU.

Data obtained from the intraoral device and/or reporting station and/or external instruments can be analyzed in a variety of ways. For example, two or more of a patient's data sets, collected at different points in time or different time intervals, can be combined or compared to reveal trends in behavior changes and responses to therapy. Data can be graphically represented to note trends in behavior and allow adjustments to therapy. These data can alert a patient and/or their health care provider that they are responding or not responding to therapy. Further, the data can be used to generate reports so that the user's behavior is made known to the patient who may not be conscious of or may be in denial of their behavior, and/or to the health care provider and/or friends or family members of the patient who may not have witnessed the behavior. These full disclosures of objective data regarding the undesirable behavior may in itself provide both negative and positive feedback which may result in reduction or elimination of the undesirable behavior.

Several variations of intraoral devices have been described herein. Similarly, there are several modes or methods of using these varieties of intraoral devices. For example, in one mode, an intraoral device may simply detect a behavior; in another mode, it may alert upon detecting a behavior; in yet another mode, it may deliver a negative stimulus upon detection of a behavior; in still another mode, it might simply log data about behavior (with or without an alert or negative stimulus or other output); in yet another mode it may provide an output as well as logging data. The configuration of the device and its mode of operation can be selected to accommodate a patient's needs or to optimize its use in the patient's therapy.

A method of providing therapeutic intervention to deter an undesirable behavior, comprising the steps of providing an intraoral unit fixed to the user's teeth or bony structure in the oral cavity such that it is difficult for the user to remove the unit him- or herself. The intraoral unit includes a detector that senses a parameter indicative of the occurrence of a predefined behavior. The intraoral unit is coupled to data storage which is either within the intraoral unit or the intraoral unit is able to relay sensed data to an external unit. Data storage may reside both in the intraoral unit or in an external unit. The method further includes the step of relaying the data from the intraoral unit to a processing unit to analyze the data. This method may, optionally, include the provision and operation of an output device to deliver an alert or negative stimulus upon sensing a condition.

As used herein, a “CPU” or “computer” is any device with digital data storage and processing capabilities. This includes “computers” (desktop and laptops) as well as handheld devices (such as smart phones and PDAs). A CPU may be general purpose, running software that facilitates the functions described herein; alternatively a CPU may be dedicated to supporting this system and method. CPU's are preferably coupled to at least one user input device (e.g. keyboard, mouse) and is preferably coupled to at least one display. A printer coupled to the CPU is useful for printing reports.

From the foregoing, it will be apparent to those skilled in the art that the present invention provides, in exemplary no-limiting embodiments, an intraoral aversion device. Further, those skilled in the art will recognize that the present invention may be manifested in a variety of forms other than the specific embodiments described and contemplated herein. Accordingly, departures in form and detail may be made without departing from the scope and spirit of the present invention as described in the appended claims.

What is claimed is:

1. A device for collecting data indicative of a behavior comprising:
a) an intraoral unit fixed to the user's teeth or bony structure in the oral cavity such that it is difficult for the user to remove the unit him- or herself, said intraoral unit including a detector that senses a parameter indicative of the occurrence of a predefined behavior;
b) means for data storage coupled to said detector to store data reflecting sensed conditions.

2. A device according to claim 1 wherein said intraoral unit includes said data storage means.

3. A device according to claim 1, wherein said intraoral unit includes means for transmitting data via a first communication path, said device further comprising:
a) a reporting station, external to the patient's mouth, configured to receive data transmitted by said intraoral unit via said first communication path.

4. A device according to claim 3, wherein said reporting station includes said means for data storage.

5. A device according to claim 3, wherein said reporting station includes means for data processing.

6. A device according to claim 3, wherein said reporting station includes means for displaying data.

7. A device according to claim 5, wherein said reporting station includes means for generating reports about the patient's behavior from said data.

8. A device according to claim 3 wherein said intraoral unit and said reporting station include mating electrical connectors that allow data transmission therebetween.

9. A device according to claim 3 wherein said intraoral unit and said reporting station include ports for connecting to an electrical cable to allow data transmission between said unit and station via the cable.

10. A device according to claim 3 wherein said intraoral unit includes a transmitter for wirelessly transmitting data and said reporting station includes a receiver configured to receive data transmitted wirelessly by said intraoral unit transmitter.

11. A device according to claim 3 wherein said reporting station is configured to be worn on a patient's body.

12. A device according to claim 1, wherein said intraoral unit includes means for transmitting data via a communication path, said device further comprising:
a) a remote central processing unit, external to the patient's mouth, configured to receive data transmitted by said intraoral unit via said communication path.

13. A device according to claim 3, wherein said reporting station is configured to transmit data via a second communication path and further comprising:
a) a remote central processing unit external to the patient's mouth, configured to receive data transmitted by said reporting station via said second communication path.

14. A device according to claim 13, wherein said central processing unit includes means for storing data received from said reporting station.

15. A device according to claim 13, wherein said central processing unit includes means for processing data received from said reporting station.

16. A device according to claim 13, wherein said central processing unit is coupled to display means.

17. A device according to claim 3, wherein said intraoral unit is configured to transmit data to said reporting station continually.

18. A device according to claim 3, wherein said intraoral unit is configured to transmit data to said reporting station periodically.

19. A device according to claim 3, wherein said intraoral unit is configured to transmit data to said reporting station on demand.

20. A device according to claim 12, wherein said intraoral unit is configured to transmit data to said central processing unit continually.

21. A device according to claim 12, wherein said intraoral unit is configured to transmit data to said central processing unit periodically.

22. A device according to claim 12, wherein said intraoral unit is configured to transmit data to said central processing unit on demand.

23. A device according to claim 1 wherein said detector detects a parameter indicative of an undesired activity selected from the group consisting of tobacco chewing, smoking, snuff use, illicit drug use, excessive alcohol use, and excessive food consumption.

24. A device according to claim 1 wherein said device further includes an output device, said output device in communication with said detector.

25. A device according to claim 24, wherein said output device is configured to deliver a stimulus and wherein said output device is disposed within the oral cavity.

26. A device according to claim 24 wherein said device further includes an output device configured to deliver an alert, said output device in communication with said detector.

26. A device according to claim 1 wherein said device includes an electrical circuit for tracking time.

27. A device according to claim 1 wherein said device includes an electrical circuit for counting the number of occurrences of a predetermined sensed event.

28. A device according to claim 25 wherein said device includes an electrical circuit for counting the number of stimuli delivered.

29. A method of providing therapeutic intervention to deter an undesirable behavior, comprising the steps of:
a) providing:
i) an intraoral unit fixed to the user's teeth or bony structure in the oral cavity such that it is difficult for the user to remove the unit him- or herself, said intraoral unit including a detector that senses a parameter indicative of the occurrence of a predefined behavior;
ii) means for data storage coupled to said detector to store data reflecting sensed conditions;
b) analyzing said data.
